(19) United States
(12) Patent Application Publication
(10) Pub. No.: US 2011/0084951 A1
(43) Pub. Date: Apr. 14, 2011

(54) DISPLAY DEVICE WITH SELECTABLE OPERATIONAL MODES, METHOD IN A DISPLAY DEVICE AND A CONTROL DEVICE TO ALTER OPERATIONAL MODE OF A DISPLAY DEVICE

(75) Inventors: Hannu Karhuketo, Valkeakoski (FI); Alan Wright, Fair Haven, NJ (US)

(73) Assignee: MARISENSE OY, Vantaa (FI)

(21) Appl. No.: 12/918,972

(22) PCT Filed: Feb. 23, 2009
(86) PCT No.: PCT/FI2009/050144

§ 371 Date: Jan. 3, 2011

Related U.S. Application Data
(60) Provisional application No. 61/064,227, filed on Feb. 22, 2008.

(51) Int. Cl. G06F 3/038

(52) U.S. Cl. 345/211

(57) ABSTRACT

A display device with wireless communication capabilities for communicating with an external control system. The device has a first operating mode and a second operating mode. A power consumption of the device in the first operating mode is different from a power consumption of the device in the second operating mode. The device is arranged to change from the first operating mode to the second operating mode based on a signal sent by an external control system.

### FIELD OF THE INVENTION

This invention relates to a display device as defined in the attached independent patent claim 1. Further, the invention relates also to a method in a display device according to the attached independent patent claim 11. In addition, the invention relates to a control device according to the attached independent claim 20.

### BACKGROUND

Electronically controllable compact display units find new and wider applications continuously. A well-known and a steadily growing field of applications can be found in stores and warehouses, where instead of conventional paper price labels on the shelves, the prices and other product related information is displayed using Electronic Shelf Labels (ESL). ESLs are particularly suitable for use in large shops or supermarkets that offer thousands or tens of thousands product items for sale, whose prices must be updated frequently and correctly.

According to the conventional technology, the price information on supermarket labels is changed manually using information printed on paper labels. New prices are printed out on paper or a similar sheet material and small labels are placed manually in corresponding holders on the shelves. This tedious method involves first finding the correct place for the updated price label, and then removing the old label and replacing it with a new label. This is very labour-intensive and also prone to human error. It also leaves possibility for information conflicts between prices on the shelves and prices stored in the scanners at checkouts.

To solve these problems, systems based on various electronic display technologies have been developed to be used as ESLs. These electronic displays can be updated from a central control system via wired or wireless communication. All-wired systems have obvious problems in terms of the layout limitations caused by the complicated cabling needed to connect to a large number of individual ESL displays. Wireless systems have as their major technological problem the need for individual power supplies for each ESL display module and requirement for long power supply lifetime, i.e. operational lifetime for the batteries. In addition, the wireless systems have to provide a dependable communication channel in an environment that has many, possibly interfering, receiver-transmitter, and in order to prolong the battery life, this communication must be done using very little power.

One type of display technology suitable for ESL module applications is

Electronic Paper Displays (EPD). These possess a paper-like high contrast appearance, ultra-low power consumption, and a thin, light form. EPDs give the viewer the experience of reading from paper, while allowing updates of the displayed information. EPDs are a technology enabled, as one possibility, by electronic ink. Such ink carries a charge enabling it to be updated through electronics. Electronic ink is well suited for EPDs as it is a reflective technology which requires no front- or backlight, is viewable under a wide range of lighting conditions, including direct sunlight, and requires no power to maintain an image. Power is only consumed when the displayed data is changed, during the period when displayed data remains constant, there is negligible power consumption.

Wireless ESLs or corresponding electronically controlled wireless display modules are faced with a number of severe requirements especially concerning the power consumption and overall battery life. Typically, in these compact devices one or more batteries are installed into the assembled device during the manufacturing phase. Often the batteries are installed permanently and can not be replaced.

The time period between the manufacturing of the device (battery installed) and the actual taking into use in a shop may be significant, and any additional power consumption during this period should be avoided because it will shorten the active service life of device. At the same time, any tedious ways to power up the devices, or need for any additional power switches or buttons in the device should be avoided to keep the device structures as simple as possible to achieve low cost. Further, to lengthen the battery life during active use of the devices, the devices should be designed in such a way that the power consumption can be kept at minimum.

It is clear, that none of the existing prior art display devices and related techniques can fully satisfy these above mentioned requirements. Therefore, there is a clear need for further inventive development in this area.

### SUMMARY

The aim of the current invention is to provide a novel and inventive display module that can be put into different operational modes depending on the situation in order to minimize power consumption and to lengthen the service life of the device. Further, the invention also describes also new methods in a display module to maintain and change state between the different operational modes. In addition, the invention describes a control device that can be used to alter the operational mode of the display module in a new and inventive manner keeping the structure of the display module very simple and not requiring any push buttons or other similar switches arranged on the display module.

In other words and broadly stated, the invention aims to provide an electronically controlled display device with wireless communication capabilities to communicate with an outside control system, characterized in that the device comprises more than one operational mode to alter the power consumption of the device based on changing its ability to respond to transmissions from the outside control system.

In order to fully understand the benefits of the invention, it should be kept in mind that display modules, such as ESL modules, are preferably encapsulated as substantially thin and flexible laminated structures that provide good protection against mechanical impacts. These modules typically aim to have completely smooth outer surface and even thickness to aid overall manageability (manual or automatic) and any buttons, switches or similar components that project from or otherwise interrupt the outer surface are highly undesirable.

Below, the invention is described in detail using application examples, by referring to the appended figures.

### BRIEF DESCRIPTION OF THE DRAWINGS

FIG. 1 shows a generic example of a shop system using ESL displays,

FIG. 2 shows an example of an ESL module together with a plastic shelf holder,

FIG. 3 shows an ESL module shown in a three-dimensional view to show the thickness and smooth surfaces of the module,

FIG. 4 shows simplified schematics of the electrical sub-modules of an ESL module,

FIG. 5 shows schematics corresponding to FIG. 4 with circuitry relevant for zombie mode highlighted,

FIG. 6 shows schematics corresponding to FIG. 4 with circuitry relevant for deep sleep mode highlighted,

FIG. 7 shows simplified schematics of an example of the power detection circuit sub-module in an ESL module, and

FIG. 8 shows simplified schematics of an example of wake-up circuitry in a control device used to alter the operational mode of an ESL module.

### DETAILED DESCRIPTION

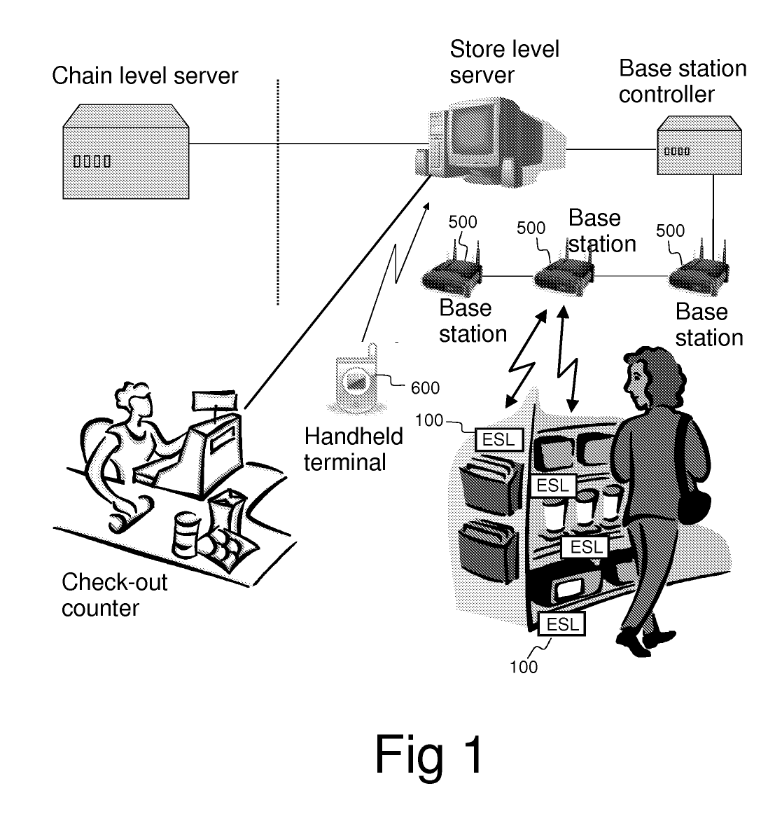

FIG. 1 shows schematically, as an example, a typical arrangement of the use of ESL displays in a supermarket or similar sales environment.

Shelves are equipped with ESL displays that are typically attached in shelf rails carrying plastic ESL holders. ESL displays are placed in locations corresponding to the products on the shelves to be easily perceivable for the customers.

ESL displays communicate in a wireless manner with the base stations 500. This wireless communication method may be based on any known wireless communication technology, but in order to save battery life of the ESL modules, passive backscatter radio communication is preferred. In this approach the base stations 500 actively send radio signals and instead of answering with active radio transmission, the ESL modules 100 do not use a radio transmitter; instead, they answer by modulating the reflected power of the base station signal. The modulation is achieved by changing the load state of the ESL antenna in the ESL module, typically, by alternately connecting the antenna to loads of differing radio frequency impedances. This modulation of the backscattered signal allows for the ESL modules to answer to the base stations 500 and these replies to be further sent to the store level server.

Each ESL module 100 can be identified by its own identification code that the ESL module in question uses to selectively listen for transmissions from the base station 500 intended to be received by the said ESL module. After receiving new information, instructions or commands from the store server via bases station, the ESL module can acknowledge the receipt of these instructions by producing properly modulated reflections of the base station's radio signal. Information may be encoded onto the modulated reflected signal, and this information can be used by the base station 500 or store level server to identify that the response is coming from the intended ESL module. To further ensure that the modulated reflections are coming from the intended ESL module, the base station 500 or store server may have a certain listening period after transmission reserved for the intended ESL to answer during that time.

Base stations 500 are typically connected in a wired manner, for example, via Ethernet connection to a base station controller. This base station controller is further connected to a store level server containing the price and other product information.

When price information is changed in the store level server locally according to pre-programmed instructions therein or manually by the shopkeeper or, remotely, from instructions received from a store chain level server, this information will be delivered through the base stations 500 to individual ESL displays 100.

The corresponding price information is also made available to the check-out counter that in arranged in communication with the store level server.

A further possibility for modifying the content of the information sent to individual ESL displays 100 is the use of a handheld terminal (this functionality not shown in FIG. 1). Such a handheld terminal can be used by a member of the shop staff allowing him/her to freely move around in the shop and communicate in a wireless manner with the store level server. The handheld terminal can contain only limited functionalities or depending on the processing power of the device, it can be used to control the full capability of the application running in the store level server. In some applications in smaller shops with fewer ESL displays 100, a handheld terminal may be used instead of a separate store level server.

Further, the store level server can be used in connection with a store chain level server to provide identical price and product information to several stores belonging to the same chain of stores.

It is clear for a person skilled in the art that the software applications, communication functions and other functions of the system described schematically in FIG. 1 can be arranged in a wide variety of different ways depending on the details of the application in question. FIG. 1 only aims to provide a high level illustration as an example to aid for understanding the benefits of the invention described here.

In order to give better understanding of the nature of the ESL modules,

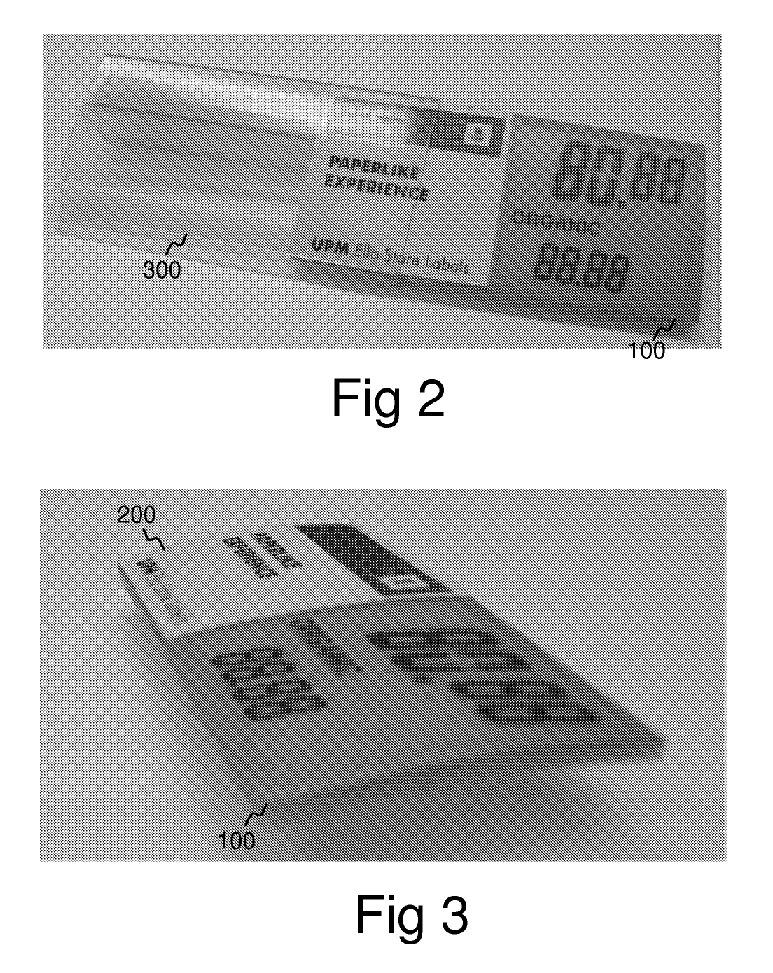

FIG. 2 shows schematically an ESL display module 100 together with a plastic holder 300 and the display module 100 partly pushed inside said holder 300. The holder 300 can be attached, typically, to the front rail of a shelf and facilitates easy installation of the ESL display 100. The holder 300 can have various shapes and sizes and be manufactured from pressed or extruded plastic, for example. The holder 300 may clip into the shelf rail or it can also be attached, for example, using adhesive such as double-sided tape. The ESL module 100 may also be attached directly to the shelf or other structure without a separate holder depending on the application.

In the example embodiment in FIG. 2, the size of the ESL module 100 is approximately 90 mm (width)×45 mm (height)×2 mm (thickness). This gives the display module 100, or label a convenient size for convenient manual handling, occupying a suitably sized space in the shelf and also large enough text and numbers to be easily visible for a customer.

FIG. 3 shows the same ESL module as in FIG. 2 but from different perspective to more clearly show the surface of the label 100. Such a shape having even thickness without protruding rims or protruding buttons is highly preferred in many applications. It makes, among other things, the use of simple slide-in holders as described in the FIG. 2 possible. The ESL display device may further have a printed label 200 attached on its surface.

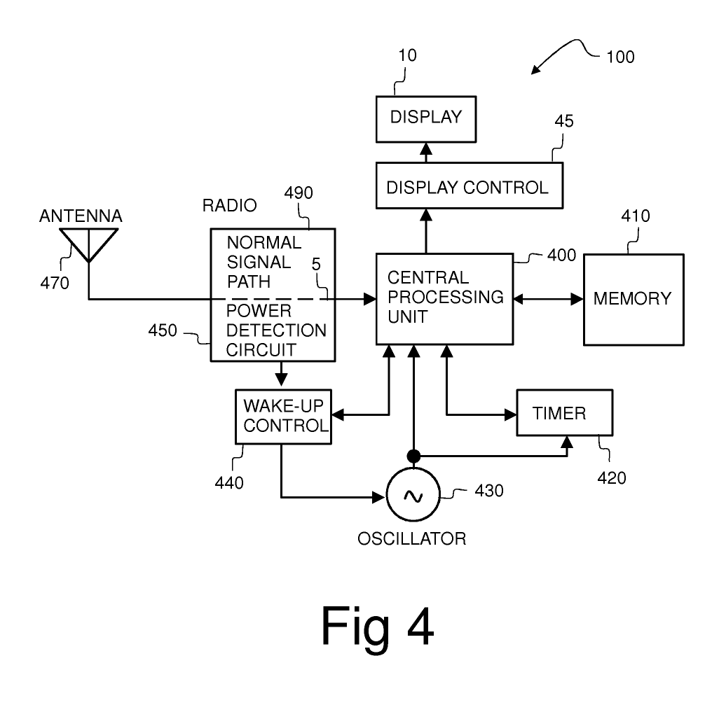

FIG. 4 describes schematically the typical main blocks of an ESL module 100. It should be noted that depending on the application the blocks might be somewhat different and thus FIG. 4 is only intended to facilitate the discussion and description of the invention below.

The signal from antenna 470 goes into radio block 490 that according to the invention has two different functions. In normal operation mode, the signal goes through the normal signal path 5 and is then interpreted by the central processing unit 400 (CPU). The CPU 400 is connected to a memory 410 where, for example, data to be displayed can be stored and according to later instructions then displayed on the display 10. To drive electronically the display 10, a display control block 45 is arranged in the ESL module 100. Further, the ESL module 100 according to the invention has an oscillator 430 to time the executions of commands in the CPU 400 and to provide basic time-base for a separate timer 420, in addition to the CPU 400 itself. This timer 420 can be used to calculate periods of time needed for any timed functions in the ESL 100. The radio block 490 has an additional power detection circuitry 450 that is connected to a wake-up control module 440. The wake-up control module 440 can control the oscillator 430 in a manner described in more detail below.

In addition to the blocks shown in FIG. 4, an ESL module 100 comprises an internal power source that makes wireless operation possible. Typically this power source is a battery, but the invention is not limited only to such solutions. The power source might be based on, for example, solar cell, inductive power feed or any other type of wireless power source without using a battery or together with a battery. The invention is directed to minimize power consumption of any power source that might have limited power resources of any kind.

According to the invention, the ESL module 100 can have various operational modes, where the power consumption is limited to different levels. Below, three different modes are described in more detail.

Normal mode—in this mode the ESL 100 has basically normal response times to any transmission from the base stations 500 and store level server. In other words, the ESL is listening the server transmissions continuously or periodically at its normal rate and acknowledges receipt of instructions without extra delays. In this mode the power consumption is at the normal level.

Deep sleep mode—in this mode ESL module 100 is not actively listening transmissions from the base stations 500 for a certain period called “sleep time” after detecting that the base station 500 is not transmitting, or after the base station 500 (server) has sent a message to the ESL module 100 informing that there will be no further transmissions addressed to that individual ESL module 100 for some specified period of time. In the deep sleep mode, the ESL module 100 can switch off most of its circuits and only keep the oscillator 430 and the timer 420 powered. The oscillator 430 and timer 420 are required so that the ESL module 100 can wake up and check again if a base station 500 is transmitting after the sleep time has elapsed. While in the deep sleep mode, the ESL 100 cannot receive any data through the normal radio interface, because it is turned off. In this mode the power consumption is significantly reduced compared to the normal mode.

Zombie mode—in this mode the ESL module 100 shuts off further system components compared to the deep sleep mode. All other components can have their power shut off except for a circuitry that detects the presence of a radio signal (or other corresponding electromagnetic wake up signal) and a circuit which starts the oscillator 430 and CPU 400 when a sufficiently large signal, so called wake up signal is detected. The ESL 100 cannot wake up from this state unless it receives the special wake up signal. In this mode the power consumption is at minimum level.

In addition to these modes, there can be further operational modes in the ESL 100 that can combine different features of the three basic modes by, for example, shutting down more or less components/blocks and thus effecting the response times and power consumption of the ESL module 100.

The usage of these different modes can vary. The normal mode is usable in situations where, for example, a significant amount of data/instructions is sent to the ESL module 100 as several successive messages. Each ESL module 100 can be identified by its own identification code that the ESL module 100 in question knows to listen for in the transmission from the base station 500. After receiving new information, instructions or commands, the ESL module acknowledges the receipt of these instructions by using, for example, the reflected modulated backscatter in a proper and timely manner for the store level server to identify that the response is coming from the ESL module 100 in question. To facilitate this, the store server may have a certain listening period after a transmission directed to a certain ESL module 100 for giving the module possibility to answer during that time. In normal operation mode, the transmission of several separate messages from the server to the ESL 100 in this manner can be arranged in short period of time because the ESL 100 is active and ready to communicate in basically continuous manner.

The deep sleep mode is suitable to be used in situations, where no communication is expected from the base station 500/server for a certain period of time. Using this mode the ESL module 100 can be timed to wake up, for example, after every 10 minutes to listen actively transmissions for a 1 minute period. A typical deep sleep target could be, for example, to keep the ESL modules 100 in the deep sleep mode 90-95% of the time. This time can be evenly distributed around the clock, or unevenly distributed to concentrate wake up time towards one or more periods during the day or night. Different days of the week could have different deep sleep mode profiles.

The zombie mode is suitable to be used in situations, where the ESL module 100 can be put to sleep for a prolonged period of time. Typically, such a situation could be the period after manufacturing of the ESL module 100 and before taking the module 100 into active use in a shop. For any storage period, the ESL module 100 can be put to zombie mode and then awakened using the method according to the invention. Such situations could include, but are not limited to, alterations made in the shops, reuse of the ESL modules 100 in some other premises and the intermediate storage of the modules 100, or very permanent types of sale arrangements, where the product information and prices will remain the same for a long period of time. It should be noted that even in the zombie mode, the ESL module 100 can continue to display information if the display is based, for example, on EPD technology described earlier.

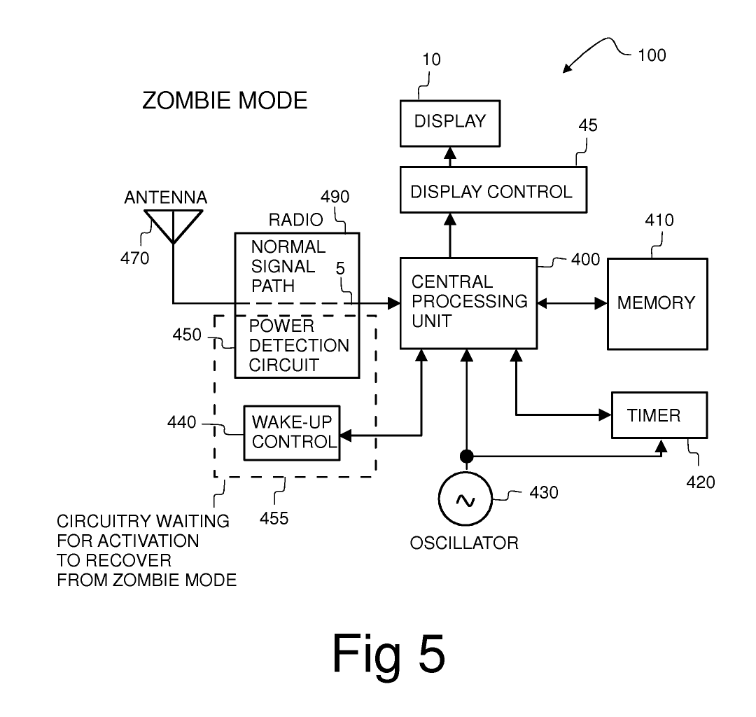

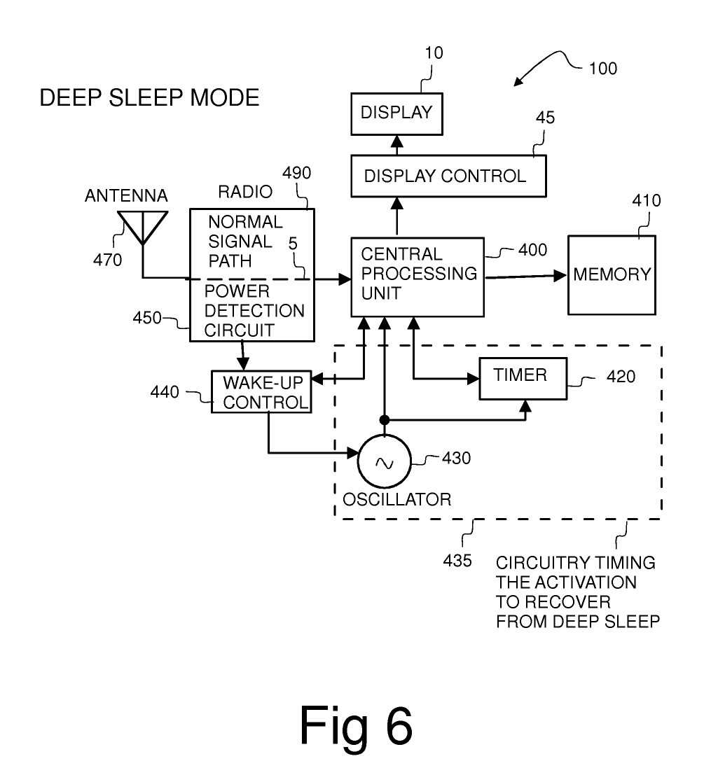

In the following the zombie and deep sleep modes are described in more details referring to FIGS. 5-8.

FIG. 5 highlights with the dashed line the system elements involved in zombie mode. These are the “Power Detection Circuit 450” in the radio block 490 and the “Wake up Control” block 440.

The main idea of the zombie mode is that all of the system components in the ESL module can have their power shut off except for a circuit 450 that detects the presence of a radio signal (Power Detection Circuit) and a circuit 440 which starts the oscillator and CPU when a sufficiently large radio signal is detected (Wake up Control). It is also possible that the power is not shut off to the other circuit elements but basically the same result is achieved by only turning off, or significantly slowing down, the oscillator 430. Since most digital circuits require an oscillator for synchronization and control of the circuit functions, stopping the oscillator may reduce the power consumption to near zero level.

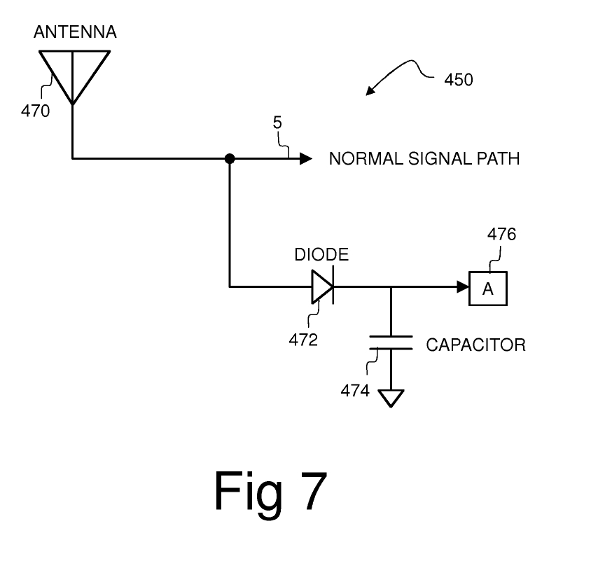

One possible form of the Power Detection Circuit 450 is shown in FIG. 7. The radio signal from the antenna 470 is rectified by a diode 472, and filtered by a capacitor 474. A sufficiently large signal at a point 476, which is marked by the symbol “A”, can be used to turn/switch on a transistor in the “Wake up Control” block 440 that subsequently turns on the oscillator 430 and notifies the CPU 400 that a large radio signal has been detected.

The circuit in the “Wake Up Control” 440 can be designed so that even if the circuit (switching transistor) has a voltage applied on when waiting for the wake up and for the RF generated voltage turn/switch on the circuit, during the waiting period the power consumption is negligible and mainly only due to leakage currents.

A key point about the “Power Detection Circuit” 450 is that it requires no electrical power (battery power) to operate. The signal is generated by power extracted from the radio signal detected by the antenna 470. No battery power is required while the circuit 450 is listening for the wake-up signal. It is also a possibility to use an amplifier using very low power in the “Power Detection Circuit” 450 to facilitate even smaller radio signals to trigger the wake-up circuit. This would however consume some battery power.

There are two possible ways for the ESL module 100 to enter into the zombie mode. The first is for an external signal to shut off the oscillator 430 and enable the power detection and wake-up circuit. For example, this could be done on the production line after the battery is attached to the ESL module 100. The ESL module 100 can then be put into zombie mode until it arrives at the customer's site. It is also possible for the CPU 400 of the ESL 100 to command the start of zombie mode, by writing to registers that configure the power detection and wake-up circuits, then commanding the oscillator 430 to shut off. This makes it possible, for example, for the shop level server to command all or selected ESL modules 100 in the shop to enter into the zombie mode.

FIG. 6 describes schematically the system elements of the ESL module involved in the deep sleep mode. These are “Oscillator” 430 and “Timer” 420.

In deep sleep mode the ESL module 100 minimizes its power consumption by shutting off most of its circuits when there are no radio messages being sent by the base station 500.

The base stations 500 send messages to the ESL modules 100 giving them information to be stored in the ESL's internal memory 410 and indicating which information should appear on the ESL display 100. These messages are usually quite short, and in a typical store where only a few hundred prices change each day, the total transmission time may only be a few minutes each day. A typical price message may only require one hundred bits, and radio systems with ranges of 10 to 20 meters can easily operate at 1000 bit/s. The ESL modules 100, depending on the communication techniques selected, may also send messages back to the base station 500, for example, to indicate successful reception of a message, or to report other conditions. Full two-way communication is not essential, but positive acknowledgements from the ESL modules 100 allow the base station 500 to stop transmitting as soon as all transmitted messages are acknowledged.

Since the base station 500 or store server transmitter sends messages only a small portion of the time, the ESL module will waste a lot of power if it constantly listens for messages. The deep sleep mode allows the module to go into a power conserving state most of the time. On some scheduled periods of time, either predetermined or adaptively generated within the ESL module 100, the ESL module 100 must wake up and check for transmissions from the base station 500/server.

If the ESL modules 100 are programmed to adaptively go into deep sleep mode when there are no transmissions from the base station 500, in order for the base station 500 to ensure that all ESL modules 100 are listening for messages, the base station 500 must either constantly send actual messages or empty “dummy” messages that are addressed to no individual ESL module 100, but only aimed to serve to keep the ESL modules 100 awake and listening.

In another embodiment according to the invention, it may be so that the base station 500 or server has a programmed algorithm used to determine the sleep times for the individual ESL modules 100. These sleep times can be transmitted to the ESL modules 100, or the modules 100 can use the same algorithm to generate the sleep times once the base station 500 has stopped transmitting. In this case, the base station 500 can schedule its next transmissions (if any) for a time in the future when the ESL modules 100 will be listening for messages.

Therefore, the sleep time period can be basically determined solely by the ESL module 100 itself (adaptively based on transmission history and/or current transmission state of the base station 500), or the sleep time period can be determined using an algorithm that is common both for the base station 500/server and the individual ESL module 100 (a general algorithm made individual for an ESL module 100 by using one or more module specific parameters), or the base station 500/server can send the ESL module 100 instructions when to sleep and when to be awake. Further, the method for determining the sleep period may be any combination from these.

After having been entered into the deep sleep mode via any of the methods describe above, the ESL module 100 can switch off most of its circuits, and only keep the oscillator 430 and the timer 420 powered. The oscillator 430 and timer 420 are required so that the module can wake up at the predetermined time and check again if a base station 500 is transmitting. While in the deep sleep mode, the ESL module 100 cannot receive any data through the normal radio interface, because it is turned off.

An ESL module 100 can notice that no base stations 500 are transmitting by several methods. The module 100 may notice that no more data using the identification code of that individual module 100 is being sent, or no radio signal using the base station's modulation scheme can be detected. One simple method is to use a fixed bit pattern that is sent with every message. If this bit pattern can not be detected within a specified time, the ESL module 100 can conclude that no base station 500 is transmitting and go into the deep sleep mode. Note that the fixed bit pattern can also be used to assist the ESL module 100 in synchronizing with the base station's transmitted data, or identify the beginning of messages, so it need not increase the size of the transmitted message.

Once the ESL module 100 has determined that the base station 500 is no longer transmitting and that it is ready to go into deep sleep mode, it must compute how long it will sleep if the base station 500/server have not provided that information. A long sleep time may save the most battery power, but the ESL module 100 may risk missing messages.

One possible and simple method for implementing deep sleep is that when an ESL module 100 detects that the base station 500 is no longer transmitting, it sets a timer 420 to awaken itself for a fixed time interval in the future. The module then turns off all functions except the oscillator 430 and the timer 420.

When the sleeping time period expires, the ESL module 100 wakes up.

It turns on the radio and tries to determine if the base station 500 is transmitting messages. If the base station 500 is transmitting, it exits the deep sleep mode. If not, the ESL module 100 resets the timer 420 to the deep sleep interval and turns off everything except the oscillator 430 and timer again.

This simple method illustrates the main features of the deep sleep mode. However, refinements are possible that reduce power consumption while allowing the ESL module 100 to receive messages without excessive delay.

Here are two examples:

1) The ESL module 100 can adaptively determine how long it should stay in deep sleep. In this method, the ESL module 100 initially wakes up frequently to check if the base station 500 is transmitting. The ESL module 100 records the times when the base station 500 was transmitting. From the distribution of recorded transmission times, the ESL module 100 can calculate how long the deep sleep period/interval should be. A simple calculation might be to set the deep sleep period o a fixed fraction (say 60 percent) of the average time between base station transmissions. A more sophisticated calculation would use the distribution of transmission times to compute the longest deep sleep time that would result in no more than a fixed (say 5 percent) chance of missing the next base station transmission.

2) If the base station 500 sends messages at regular intervals, the ESL module 100 can use deep sleep to synchronize its waking periods with the times that the base station 500 is transmitting. To do this, the ESL module 100 initially uses short deep sleep intervals, waking frequently, to determine if the base station 500 is transmitting. Whenever transmissions are detected, the ESL module 100 records the time. The average difference between detected transmission times is approximately the interval between base station transmissions.

When the ESL module 100 detects that the base station 500 is no longer sending messages, it can use the estimated interval between base station transmissions as the new deep sleep interval. Or it may use a somewhat shorter interval (for example, a fixed percentage of the estimate time between base station transmissions or the estimated time between base station transmissions minus a constant) to be sure that the ESL module 100 is awake just before the base station 500 begins transmitting.

While this method can be implemented solely in the ESL module 100 itself, it could be assisted by messages from the base station 500/server indicating how frequently the base station 500 will transmit messages in the future.

Any of the described methods may be augmented with a test for a maximum deep sleep time. If the computed deep sleep time exceeds the maximum, the maximum deep sleep time is substituted for the computed deep sleep time. This guarantees that the ESL modules 100 check for messages some known fraction of the time. The maximum deep sleep time for an ESL module may set by hardware, pre-programmed into the module's software or set by a message from the base station 500/server.

The zombie mode (in FIG. 5) and the deep sleep mode (in FIG. 6) might be used completely separately but also in combination, in other words whenever a wake-up signal is identified by the wake-up control, this can interrupt also a deep sleep mode.

In the following the procedures to wake-up from the zombie mode is explained in more detail.

Waking up from zombie mode is preferably a two-step process. First, the power detection circuit 450 senses a large enough radio signal to trigger the wake up circuit. The wake up circuit 440 starts the oscillator 430 and CPU 400. Next, the CPU 400 checks that the signal detected by the power detection circuit 450 was actually intended to wake up the ESL module 100.

The above described two step process is needed because spurious radio signals may otherwise trigger the power detection circuit 450 and wake the ESL module 100 erroneously.

To check if the detected signal was actually intended to wake the ESL module 100, the CPU 400 can examine either the signal received by the power detection circuit 450 or it can enable the normal signal path 5. The CPU 400 will then search for a characteristic pulse pattern, a valid data packet or other recognizable signal indicating that that a wake up event has occurred. If no such signal is detected within some time interval, the CPU 400 may command the module 100 to return to zombie mode by enabling the power detection 450 and wake up circuits 440 and turning off the oscillator 430.

According one possible embodiment of the invention, the ESL module 100 can be configured so that after once awaking from the zombie mode, the module 100 cannot be put into this mode ever again. This might be usable in some applications, although in many applications the zombie mode can be used several times.

If the ESL module 100 uses the simple circuit shown schematically in FIG. 7, the voltage at the point 476 i.e. at the point “A” will usually need to be several hundred millivolts to turn on a transistor and begin the wake up process. For typical detector diodes 472, the signal level at the diode needs to be 0 to 10 milliwatts to achieve this. There are also other diode configurations known as such, such as the “Voltage Doubler Circuit” which only need half the power to reach a given voltage.

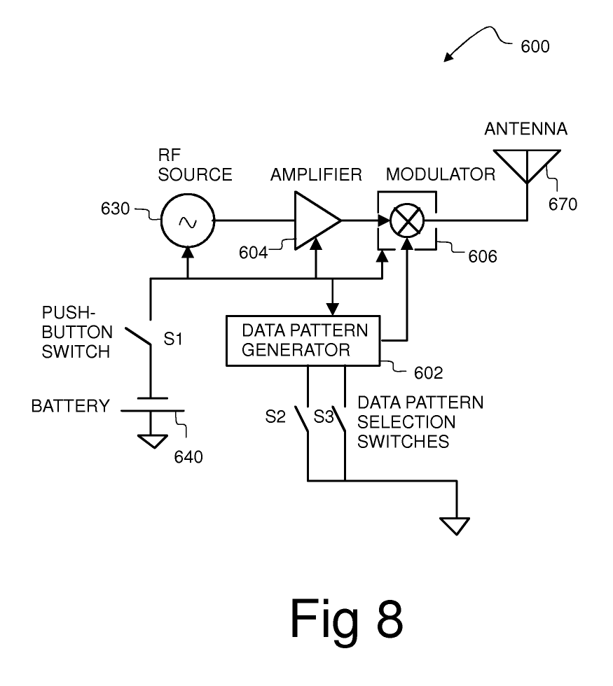

In the following, a control device to alter the operational mode of the ESL module is described with reference to FIGS. 1 and 8. This control device is referred below as “wake up key” transmitter 600.

FIG. 1 illustrates a handheld wake-up device 600 that can be used to wake up the ESL module 100 from the zombie mode (or deep sleep mode) based on strong enough radio frequency pulse targeted at the ESL module 100 from a short distance.

FIG. 8 describes schematically the basic block diagram of the control device 600, the “wake up key”.

To deliver the radio frequency signal to the diode in the power detection circuit in FIG. 7, the “wake up key” transmitter 600 according to FIG. 8 can be used as one alternative. A small battery powered transmitter 600 can typically radiate 10 milliwatts that is sufficient to wake up an ESL module 100 a few centimeters away thus making it possible to manufacture a wake up device 600 as schematically shown in FIG. 1. Such a handheld device can be conveniently used by the shop staff.

The wake up key's frequency should be preferably close to the reception frequency that the ESL module 100 was designed for, but at very short range, there is a near field coupling effect that causes the ESL module 100 radio block 490 to receive signals at frequencies considerably different from the design frequency. According to the invention, this can be used to advantage: for example, a suitably modified mobile phone could be used a “wake up key” transmitter 600. A GSM mobile phone puts out a peak power of 600 milliwatts, which is more than enough to trigger the wake up circuit several centimeters away. The phone needs to be modified to send a signal that the ESL module would recognize as an intentional wake-up signal, but regardless of that this provides one simple and economical manner to manufacture the wake-up keys 600.

FIG. 8 shows a schematic block diagram of a simple wake-up key 600 with a pushbutton switch S1 to power on the transmitter. The power source may be a battery 640. The pushbutton switch S1 energizes the radiofrequency source 630 and amplifier 604 sending radio frequency signal to the antenna 670. An additional modulator 606 is provided to generate radio signal modulated according to different data patterns selectable using additional selection switches S2, S3. The data patterns may be generated by a data pattern generator 602. The data patterns can be used, for example, to allow the ESL module 100 to determine why it was awakened.

Aside from just waking up the ESL module 100, the wake-up key 600 can cause the ESL module 100 to display new information that has been earlier stored in the internal memory of the ESL module 100. Further, the wake up key could cause the ESL module 100 to execute a diagnostic software, or force the ESL module 100 to blank its display 10 (which could let store personnel to disable a malfunctioning module, for example).

Instead of being just a simple wake-up key 600, such a control device 600 can have additional features. For example, the control device 600 can be equipped with additional wireless communication capabilities via a GSM or GPRS network allowing the control device to communicate with the store level server. For this, for example Personal Digital Assistant (PDA) type computing devices can be used. Such a handheld terminal can contain only limited functionalities or depending on the processing power of the device, it can be used to control the full capabilities of the application running in the store level server. In some applications in smaller shops with a fewer number of ESL displays 100, a handheld terminal 600 may be used instead of a separate store level server to control the ESL modules 100. Equipped with a wake up key functionality according to the invention, such a device 600 can be used for multiple purposes.

Further, an infrared transmitter can be added to the wake-up key 600. This would provide a single device 600 that could communicate with both radio and infrared based ESL modules 100. This could be used by store personnel when they replace their infrared ESL systems with radio ones.

The basic function of the wake up key device 600 is to be able to provide external energy for the ESL module 100 to wake up from the zombie mode, where the power consumption of the module 100 is negligible and thus the external energy provided by the wake up key is necessary to activate the functions of the module. Use of radio frequency pulses as described above is one possibility having the benefit that it can make use of the radio components inherent in the ESL module 100. However, also other forms of providing external energy to the ESL module 100 are possible.

For example, the energy from the wake up key 600 can be provided in the form of optical radiation, either at visible wavelengths or non-visible wavelengths (ultraviolet or infrared). Modern semiconductor light emitting diodes or laser diodes can provide high energy light that can be created into electrical power using a small sized solar cell or other light-to-electricity converting component. The use of light activated transistors is also possible. These would facilitate the short range energy activation required by the ESL module 100. Together with these, additional second step process can be used to prevent spurious signals from triggering the power detection circuit and wake the ESL module 100 erroneously. These second step processes can be based on optical or radio-wave techniques.

Further, short range inductive coupling can also be used to wake up the ESL module 100. A handheld device 600 can be designed to inductively provide external energy to the ESL module 100 to make it wake up from the zombie mode.

It is clear that the wake up key 600 does not need to be manufactured in the form of a handheld device, but if necessary, it can be arranged as a part of a system handling ESL modules 100 in automatic manner, for example. Such a device 600 can be used to wake-up the ESL modules 100 from zombie mode after long storage upon taking the ESL modules 100 into active use and, for example, in the same time adding any printed labels 200 etc. on the modules.

The above given description has been aimed only to provide examples of the invention. There can be variations in the embodiments of the invention. For example, the wireless radio communication method of the electronically controllable display modules 100 may be other than based on radio backscattering techniques.

The display module 100 may be capable of displaying electrically variable information both when it is in the deep sleep mode and in the woken up state. In particular, the display module 100 may be an electronic shelf label which is arranged to display price information also in the deep sleep mode, in addition to displaying price information in the woken up state.

The display module may further have the zombie operating mode. The display module 100 may be capable of displaying electrically variable information both when it is in the zombie mode and in the woken-up state. In particular, the display module 100 may be an electronic shelf label which is arranged to display price information also in the zombie mode, in addition to displaying price information in the woken-up state.

The display module 100 may be implemented e.g. by electronic ink and/or by electronic paper.

The total thickness of the display module 100 may be e.g. smaller than or equal to 5 mm. The total thickness of the display module 100 may be e.g. in the range of 0.5 to 2 mm.

The various aspects of the invention are illustrated by the following examples:

### EXAMPLE 1

An electronically controlled display device with wireless communication capabilities to communicate with an outside control system, characterized in that the device comprises more than one operational modes to alter the power consumption of the device based on changing its ability to respond to transmissions from the outside control system.

### EXAMPLE 2

Display device according to example 1, characterized in that the device comprises a deep sleep mode, where an internal timer is used to wake up the device after a predetermined sleeping period during which all other blocks of the device except those needed by the timer are shut off.

### EXAMPLE 3

Display device according to example 1, characterized in that the device comprises a zombie mode, where external energy in the form of electromagnetic radiation is required to wake up the device and that during the zombie sleep mode the power consumption of the device is neglible.

### EXAMPLE 4

Display device according to example 3, characterized in that said external energy is in the form of radio waves.

### EXAMPLE 5

Display device according to example 3, characterized in that said external energy is in the form of optical radiation, either ultraviolet, visible or infrared radiation.

### EXAMPLE 6

Display device according to example 5, characterized in that said external energy is laser radiation.

### EXAMPLE 7

A method in an electronically controlled display device with wireless communication capabilities to communicate with an outside control system, characterized in that the method comprises the step of changing the operational mode of the device to alter the power consumption of the device based on changing its ability to respond to transmissions from the outside control system.

### EXAMPLE 8

A method according to example 7, characterized in that the device comprises a deep sleep mode, where an internal timer is used to wake up the device after a predetermined sleeping period during which all other blocks of the device except those needed by the timer are shut off.

### EXAMPLE 9

A method according to example 8, characterized by that the internal timer is programmed using an algorithm to compute the sleeping period.

### EXAMPLE 10

A method according to example 8, characterized by that the internal timer is programmed using information received from the outside control system.

### EXAMPLE 11

A method to example 7, characterized in that the device comprises a zombie mode, where external energy in the form of electromagnetic radiation is required to wake up the device and that during the zombie sleep mode the power consumption of the device is neglible.

### EXAMPLE 12

A method according to example 11, characterized in that said external energy is in the form of radio waves.

### EXAMPLE 13

A method according to example 11, characterized in that said external energy is in the form of optical radiation, either ultraviolet, visible or infrared radiation.

### EXAMPLE 14

A method according to example 13, characterized in that said external energy is laser radiation.

### EXAMPLE 15

A control device characterized in that it is arranged to provide the external energy according to example 3 to wake up the electronically controlled display device from the zombie mode.

### EXAMPLE 16

A control device according to example 15, characterized in that it comprises a pushbutton to activate the transmission of said external energy.

### EXAMPLE 17

A control device according to example 15, characterized in that it is arranged to send user selectable data patterns to control the functions of the device to be awakened.

### EXAMPLE 18

A control device according to example 15, characterized in that it is a hand held device to be used from close proximity respect to the device to be awakened.

Even if the invention was explained above using an ESL display module as an example, the invention is not limited to ESL applications only, but the display modules according to the invention can find also use in other applications within the scope of the attached examples and claims.

1. A display device with wireless communication capabilities for communicating with an external control system, wherein said device has a first operating mode and a second operating mode, a power consumption of said device in said first operating mode being different from a power consumption of said device in said second operating mode, and wherein said device is arranged to change from said first operating mode to said second operating mode based on a signal sent by an external control system.

2. The device according to claim 1, wherein said device is capable of displaying electrically variable information in said first operating state and in said second operating state.

3. The device according to claim 1, further comprising:
a display implemented by electronic ink.

4. The device according to claim 1, wherein a total thickness of said device is smaller than or equal to 5 mm.

5. The device according to claim 1, wherein the device has a deep sleep operating mode, said device further comprising:
a timer arranged to wake up said device from said deep sleep operating mode to another operating mode after a predetermined sleeping period.

6. The device according to claim 5, wherein all other blocks of said device except those needed by the timer are arranged to be shut off during said deep sleep operating mode.

7. The device according to claim 1, wherein the device has a zombie operating mode, wherein the power consumption of the device is negligible in said zombie operating mode, and wherein said device is arranged to wake up from said zombie operating mode to another operating mode when the device is exposed to external energy in the form of electromagnetic radiation.

8. The device of according to claim 7, wherein said external energy is in the form of radio waves.

9. The device of according to claim 7, wherein said external energy is in the form of ultraviolet optical radiation, visible optical radiation, or infrared optical radiation.

10. The device according to claim 9, wherein said external energy is laser radiation.

11. A method for operating a display device, said device comprising wireless communication capabilities for communicating with an external control system, said method comprising:
changing from a first operating state of the device to a second operating state of the device based on a signal sent from said external control system, wherein the power consumption of said device in said first operating mode is different from the power consumption of said device in said second operating mode.

12. The method according to claim 11, wherein said device has a deep sleep operating mode, said method further comprising:
waking up said device from said deep sleep operating mode to another operating mode by an internal timer after a predetermined sleeping period.

13. The method according to claim 12, wherein all other blocks of said device except those needed by the timer are shut off during said deep sleep operating mode.

14. The method according to claim 12, wherein said internal timer is programmed using an algorithm to compute the sleeping period.

15. The method according to claim 14, wherein said internal timer is programmed using information received from the external control system.

16. The method according to claim 11, wherein said device has a zombie operating mode, wherein the power consumption of the device is negligible in said zombie operating mode, and said device is awakened from said zombie operating mode to another operating mode by exposing the device to external energy in the form of electromagnetic radiation.

17. The method according to claim 16, wherein said external energy is in the form of radio waves.

18. The method according to claim 16, wherein said external energy is in the form of ultraviolet optical radiation, visible optical radiation, or infrared optical radiation.

19. The method according to claim 18, wherein said external energy is in the form of laser radiation.

20. A control device arranged to provide external energy for waking up the display device with wireless communication capabilities for communicating with an external control system, wherein said device has a first operating mode and a second operating mode, the power consumption of said device in said first operating mode being different from the power consumption of said device in said second operating mode, and wherein said device is arranged to change from said first operating mode to said second operating mode based on a signal sent by an external control system, wherein the device has a deep sleep operating mode, said device comprising a timer arranged to wake up said device from said deep sleep operating mode to another operating mode after a predetermined sleeping period, wherein all other blocks of said device except those needed by the timer are arranged to be shut off during said deep sleep operating mode.

21. The control device according to claim 20, further comprising:
a user interface to activate transmission of said external energy.

22. The control device according to claim 20 arranged to send user-selectable data patterns to control the operation of said display device.

23. The control device according to claim 20, wherein said control device is a portable device.

24. The control device according to claim 21, wherein the user interface comprises a push button.

25. The device according to claim 4, wherein the total thickness of said device is in the range of 0.5 mm to 2 mm.
